(19) United States
(12) Patent Application Publication
(10) Pub. No.: US 2004/0221627 A1
(43) Pub. Date: Nov. 11, 2004

(54) Truck anti-theft device

(76) Inventor: David C. Cormier, Crestview, FL (US)

Correspondence Address: J. RONALD RICHEBOURG, 232 TALQUIN COVE, DESTIN, FL, 32541, US

(21) Appl. No.: 10/689,957

(22) Filed: Oct. 21, 2003

Related U.S. Application Data
(60) Provisional application No. 60/464,597, filed on Apr. 22, 2003.

(51) Int. Cl. G05G 1/00

(52) U.S. Cl. 70/177

(57) ABSTRACT

An anti-theft device is disclosed for use on a vehicle employing air-operated parking brakes. The device is shaped for disposal about the parking brake release valves when engaged. The device includes a pair of mating halves formed for surrounding and enclosing the control valves while in an engaged position. A first of the halves includes a tongue having an opening therein and a second of the halves includes a channel for receiving the tongue. A lock is provided with a locking pin being disposed in the second half wherein the locking pin engages the opening in said tongue in order to secure the first and second halves together. Also, an adjustment mechanism is provided for tailoring the device to minor differences between the release valves from one vehicle to another.

### CROSS REFERENCE TO RELATED APPLICATION

This is a continuation of Provisional Application Number 60/464597 filed Apr. 22, 2003.

### FIELD OF THE INVENTION

The present invention generally relates to the field of vehicular anti-theft devices and in particular to an improved anti-theft device adapted for preventing release of air-operated parking brakes on tractor-trailer truck rigs.

### BACKGROUND OF THE INVENTION

Theft of cargo carrying vehicles is a serious problem. Many billions of dollars in commercial cargo travel our highways each and every day. The value of the cargo is very enticing to those criminally inclined who profit from theft of such cargo. Notwithstanding numerous efforts to stem the tide of such crimes, the loss of stolen cargo is still a serious problem. The monetary loss of cargo also causes an increase in the price of goods to each and every citizen. Some estimates place the annual loss of cargo by theft in the billions of dollars. More recently, with emphasis on preventing or deterring terrorist activity, it is of paramount importance to prevent theft of tractor trailer rigs carrying sensitive cargo, such as weapons, volatile gases or the like.

Many efforts have been made in the past to stop or curtail cargo thefts, including the addition of guards at truck stops or the adding of guards who ride “shot-gun” on these vehicles. With specific reference to tractor-trailer truck rigs, which the present invention has specific usefulness, a typical prior art device is commonly referred to as a “king pin lock”. This device comprises a large pin which is inserted into the coupling between the tractor and the trailer in order to prevent a hook-up of a cargo-laden trailer to an outlaw tractor. Another prior art device is referred to as a “glad hand lock”, which prevents hooking up of the air brake lines between the tractor and an outlaw trailer. There are many other similar types of prior art anti-theft devices available, but none of them prevents theft of the tractor itself. If the tractor cannot be moved, then the trailer cannot be decoupled from the tractor, thereby preventing theft.

An exemplary prior art device is disclosed in U.S. Pat. No. 5,688,027, entitled CONTROL VALVE LOCK FOR A VEHICLE AIR BRAKE SYSTEM. This patent discloses a lock device that is securable to the valve actuating rod on the dashboard control valve and includes a base member to which is secured a large actuating knob. A lock cylinder extends through a portion of the knob and base member and aligns internal locking cavities between the connecting shaft of the knob and the base member whereby the locking dog of the lock cylinder can engage in the cavities to secure the knob in a retracted position thereby locking the brakes of the vehicle. In order to unlock the brakes, it is necessary to insert a key in the key cylinder to free the knob in order to permit it to be pushed in, whereby the dashboard control valve can supply air to the parking brake cylinder to release the brakes. A large disadvantage of this prior art device is that it is complicated and requires modification of the air brake control valves in order to install it on the vehicle.

### SUMMARY OF THE INVENTION

As will be amplified in greater detail hereinbelow, the present invention solves one of the prior art problems by use of a device that prevents release of the air brakes on the tractor control panel. The lock installs over and around the air control valves on the dashboard of the tractor without modifications of the control valves themselves. The function of the control valves is to control the flow of air for release of the parking brakes. These valves are of the “push/pull” type. When the valve is pushed in, the parking brakes are released by the application of air. Two valves are typically provided on the tractor dashboard wherein one controls the release of the brakes on the tractor and the other controls release of the brakes on the trailer. The valves are pulled out to engage the parking brakes. A unique device is provided that locks around and behind the air brake valves mounted on the tractor dash board, which prevents someone from pushing in the valves to release the parking brake. The only way the air brake valves may be freed up for operation is by the use of a key that opens up the device of the present invention.

Accordingly, it is an object of the present invention to provide a device and method for preventing the theft of semi tractor-trailer rigs by the use of a simple two-piece locking device that wraps around and behind the air brake release valves and one that overcomes the disadvantages of the prior art devices.

Another object of the present invention is to provide a device that is simple to manufacture and one that is simple to use, but is amply secure to prevent theft or tampering with the tractor-trailer rig.

Another object of the present invention is to provide an anti-locking device that requires no modifications to the existing air-brake control valves installed on the tractor of a tractor-trailer rig.

A feature of the present invention includes an adjustable mechanism for tailoring the anti-theft device to differences between air brake release-valves from one make of tractor to another make.

Another feature of the present invention is to provide a control valve lock that is securable to the air-brake control valve actuating mechanisms without disturbing the integrity of the parking brake system and without tapping into the air supply lines of the system and which can be adapted to difficult dashboard control valves.

These and other objects and features, which will become apparent as the invention is described in detail below, the present invention comprises a two-piece block that is contoured to wrap around and behind the air brake release valves on the dash board of the tractor. A key operated lock is disposed in one half for locking the two pieces together.

Still other objects, features and advantages of the present invention will become readily apparent to those skilled in the art from the following detailed description, wherein is shown and described only the preferred embodiment of the invention, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive. The present invention will become apparent when taken in conjunction with the following description and attached drawings, wherein like characters indicate like parts, and which drawings form a part of this application.

### BRIEF DESCRIPTION OF THE DRAWINGS

FIG. 1A is a perspective view of one side of the anti-theft device of the present invention.

FIG. 1B is a perspective view of another side of the anti-theft device of the present invention.

FIG. 2 is an exploded view of the anti-theft device of the present invention illustrating many of the component parts thereof.

FIG. 2A is an exploded view of an alternate embodiment of one half of the anti-theft device of the present invention.

FIG. 3 is an exploded/phantom view of the anti-theft device of the present invention illustrating all of the component parts thereof.

FIG. 4A is a plan view of the anti-theft device of the present invention.

FIG. 4B is a side elevation view of the anti-theft device of the present invention mounted to the dashboard of a truck.

FIG. 4C is an end view of the anti-theft device of the present invention mounted to the dashboard of a truck.

FIG. 5A is a plan view of one half of the anti-theft device of the present invention.

FIG. 5B is a side elevation view of one half of the anti-theft device of the present invention.

FIG. 5C is an end view of one half of the anti-theft device of the present invention.

FIG. 6A is a plan view of the other half of the anti-theft device of the present invention.

FIG. 6B is a side elevation view of the other half of the anti-theft device of the present invention.

FIG. 6C is an end view of the other half of the anti-theft device of the present invention.

### DETAILED DESCRIPTION OF ONE EMBODIMENT

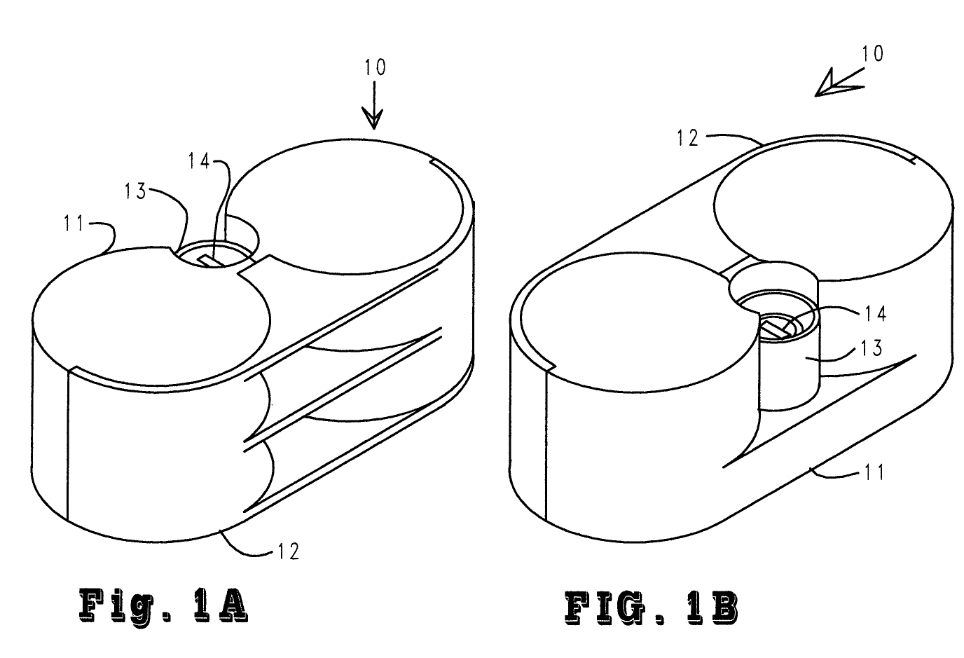

Referring now to the drawings and to FIGS. 1A and 1B in particular, perspective views of the anti-theft device 10 of the present invention are shown. The device 10 is preferably formed of plastic, such as Delrin, or metal (or any other suitable material) into two halves 11 and 12. One embodiment is to manufacture the device from a poly-carbon fiber. A lock 13 having a key slot 14 is provided for locking the two halves 11 and 12 together, as will be amplified hereinbelow. The brake release valve levers are not shown in FIGS. 1A and 1B, because they are enclosed by the device 12.

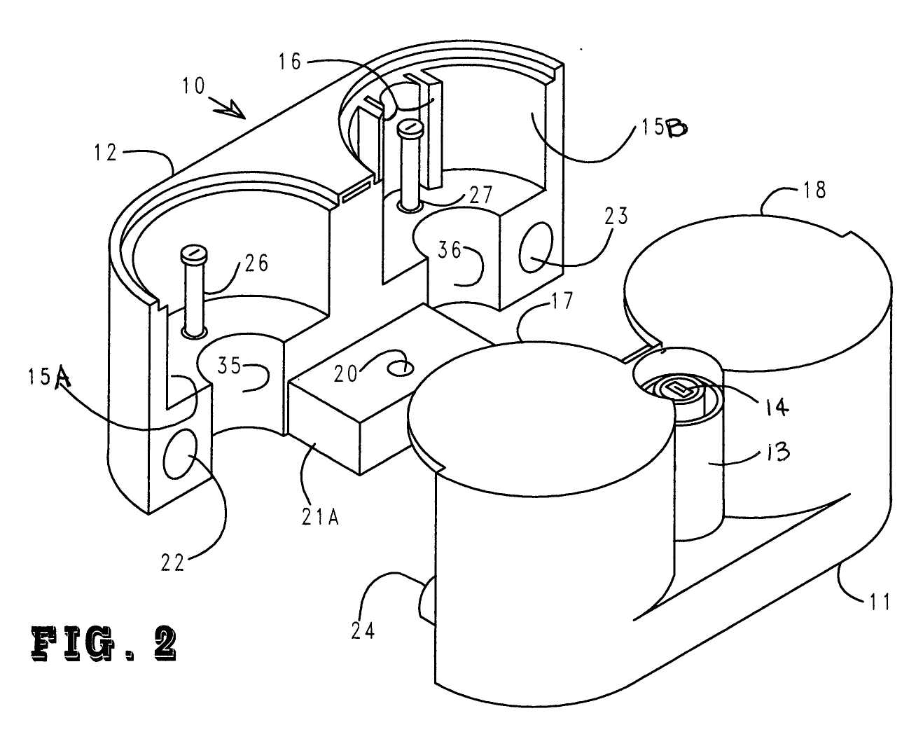

Referring now to FIG. 2, an exploded view of the device 10 is shown illustrating the various parts of the device and their interrelationship. The brake release valve levers (not shown in this drawing) are received by cavities 15A and 15B, and the shafts of the levers are received by cavities 35 and 36, all of which are formed within the halves 11 and 12 of the device 10. Note that vertical ridges 16 are formed within the cavity 15B for engaging a corner of the diamond shaped tractor air-brake release valve, which will be amplified hereinbelow.

Covers 17 and 18, which may be formed as an integral part of half 11, cover the cavities 15A and 15B, respectively, for hiding the brake release valves when the halves are joined together in a locked position as shown in FIGS. 1A and 1B. The lock 13 is illustrated in the open position, since the halves 11 and 12 are separated. When the lock is depressed downward, a pin (not shown) enters an opening 20 in a tongue 21A protruding from the half 12 of the device 10. The tongue 21A engages a matching groove 21B formed in half 11 of the device 10 (not shown in this drawing). The lock 13 will then remain in the downward position, thereby securing the halves 11 and 12 together, until a key is inserted into the slot 14 and turned to unlock the lock. The lock 13 will then pop up, which disengages the pin (not shown) from the opening 20. The two halves 11 and 12 may then be separated form one another and then removed from behind and around the air brake release valves.

Guide pins 22 and 23 are inserted into one half of the device 10, which in the illustration of FIG. 2 is half 12. The guide pins 24 and 25 (not shown in FIG. 2), enter into openings 22 and 23 respectively, formed in the half 12 of the device 10. The guide pins may be formed of metal, or any suitable material such as hardened plastic, or they may be formed of the same material as the halves 11 and 12 are formed. That is, the guide pins may be formed as a part of the same manufacturing process used to form the halves 11 and 12. A unique feature of the device of the disclosed invention are a pair of adjustment mechanisms 26 and 27 formed into the half 12. The mechanisms 26 and 27 allow the user to adjust the device to minor variations in size of air brake release valves, which may vary from one vehicle to another. According to a specific embodiment, the mechanisms 26 and 27 are threaded screws, which engage matching openings tapped into the half 12. Openings 35 and 36 are formed in the bottom (i.e., the surface opposite the lock 13) for receiving the shafts of the air brake valves. It is preferable for the openings 35 and 36 to be substantially the same diameter as that of the shafts of the air brake release levers, which in one embodiment is approximately 7/8 inch.

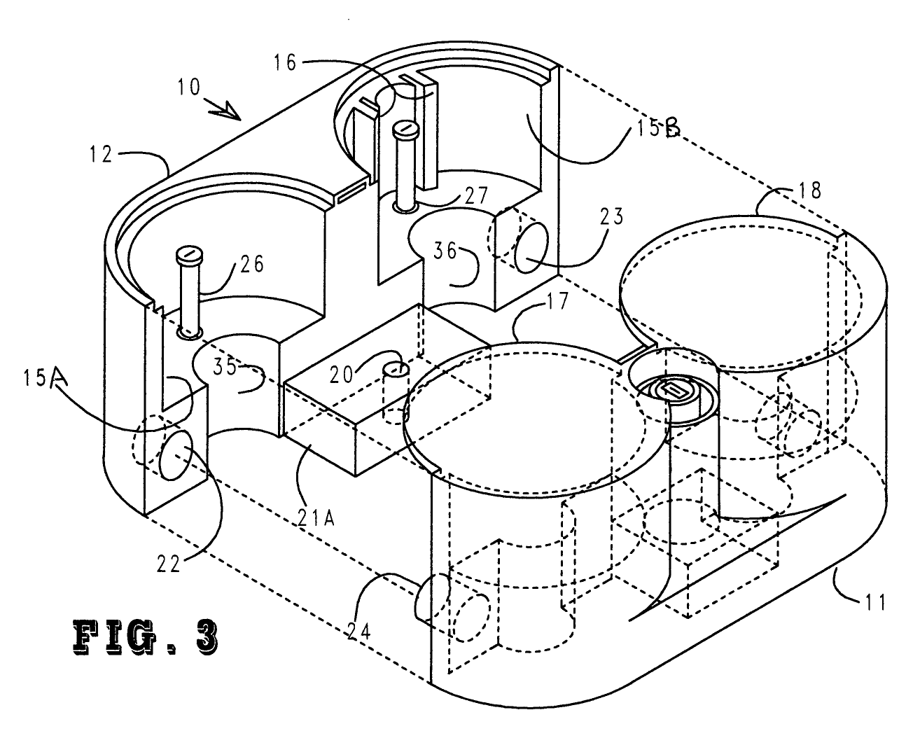

Referring now to FIG. 3, a detailed exploded view of the device of the present invention is shown. Again, the device 10 is formed of two matching halves 11 and 12. FIG. 3 shows (in phantom lines) more details than were shown in the exploded view of FIG. 2. Also, the other half of the cavities 15A and 15B are also formed into half 11 for receiving the brake release valves, as will be amplified hereinbelow.

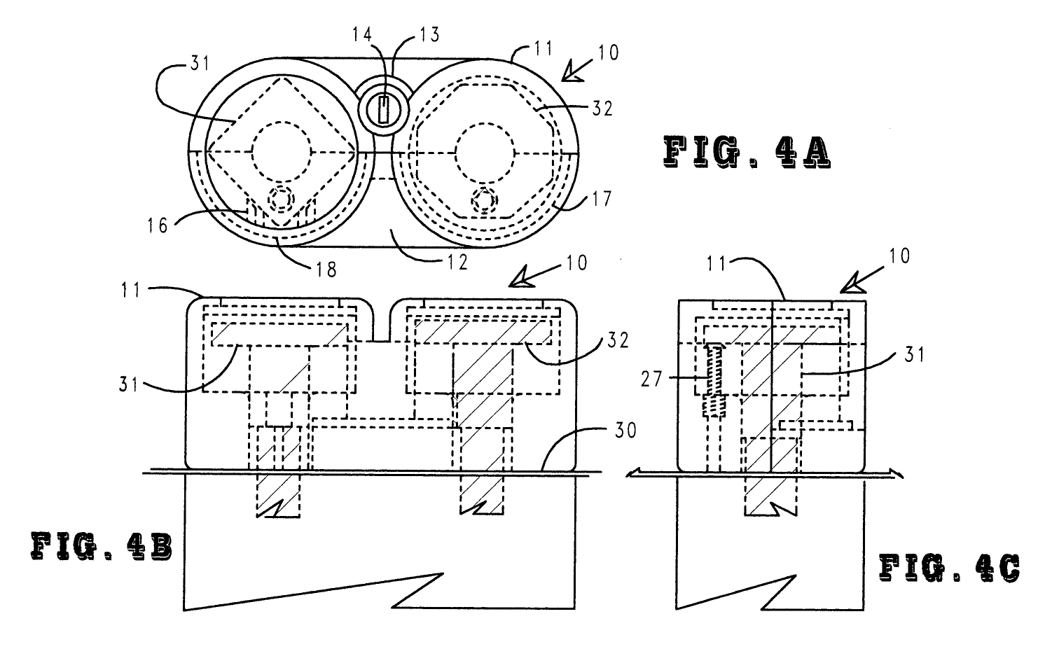

Referring now to FIGS. 4A, 4B and 4C, top, side and end views of the device 10 of the present invention are shown. Note in FIG. 4A that the ridges 16 are and in close proximity to a corner of the diamond shaped tractor air-brake release valve 31. FIGS. 4B and 4C illustrate the device 10 adjacent to the dashboard 30 of a truck, wherein air-brake release valve levers 31 and 32 may be seen in phantom lines when enclosed within the device 10. The octagonal valve lever 32 is for releasing the parking brakes for the trailer. Note in FIG. 4C the adjustment mechanism 27 is set to abut the lower rim of the tractor brake release valve lever 31. This prevents any movement of the lever 31 while the device 10 is locked around the valve levers.

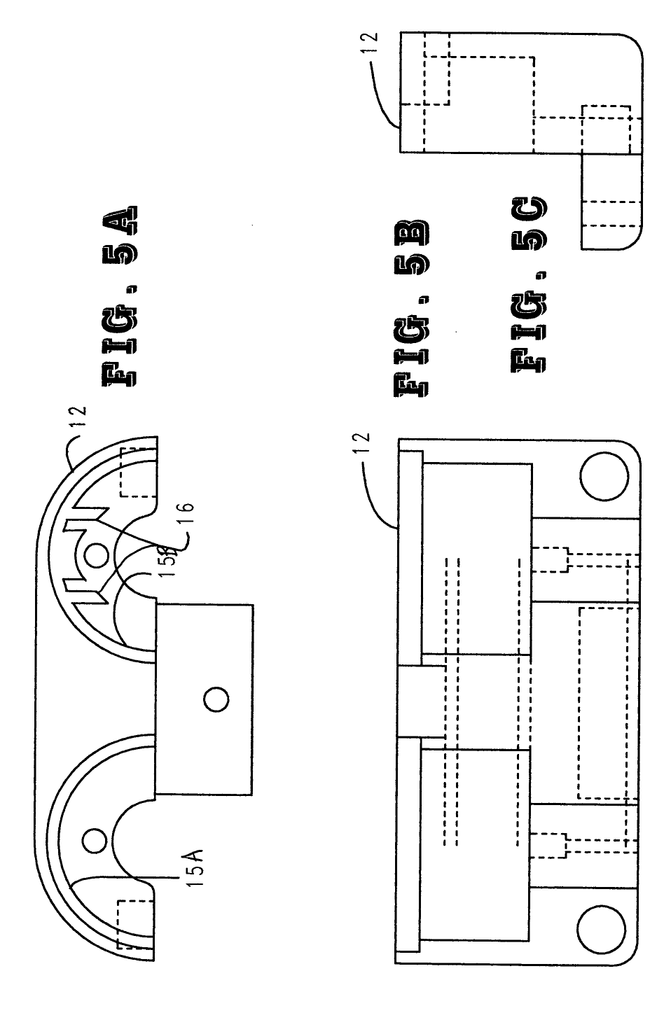

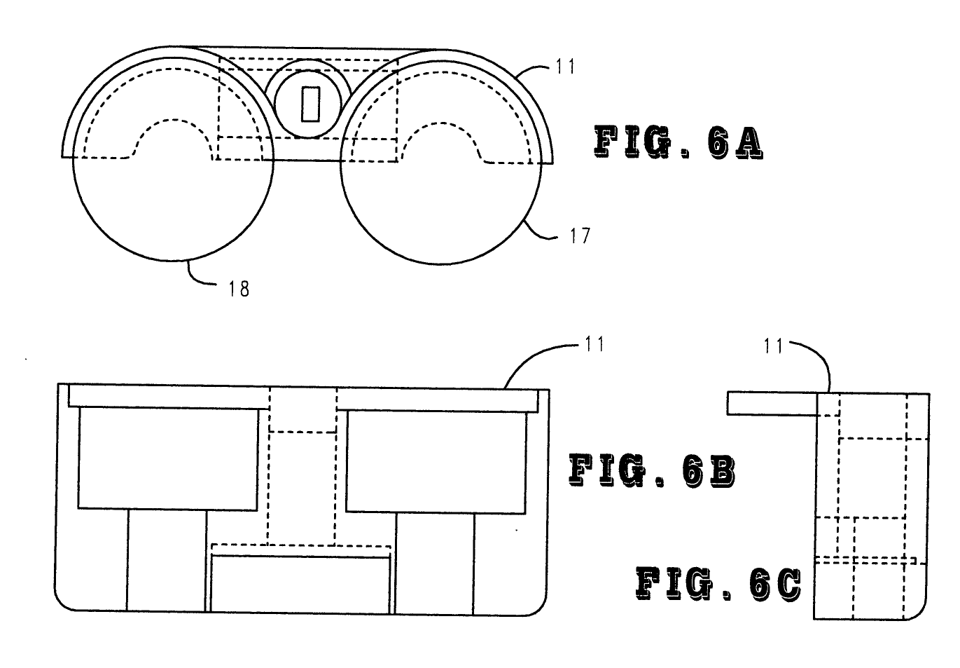

FIGS. 5A, 5B and 5C illustrate details of the half 12 of the device 10, while FIGS. 6A, 6B and 6C illustrate details of the half 11 of the same device 10.

To install the Anti-Theft Device of the present invention the top half (i.e., half 12) is installed over the tractor and trailer air brake release valves. However, it may be necessary to adjust the screw mechanisms 26 and 27 in order to snug the lock up against the underside of the valves. Once this adjustment has been made it is not necessary to repeat each time the device is installed over the same valves. The lower portion of the lock (i.e., half 11) is slid into the top portion, wherein tongue 21A engages channel 21B and guide pins 24 and 25 engage openings 22 and 23, respectively. The push-in lock 13 is then depressed, which engages opening 20 in the tongue 21A, thereby connecting the top and bottom halves (11 and 12) to secure the device around the brake release valves. By completely enclosing the valves they cannot be “pushed” in and the brakes cannot be released. Moreover, it becomes difficult if not impossible to remove the device without use of a key in the lock 13.

Although the invention has been described with reference to a specific embodiment, this description is not meant to be construed in a limiting sense. Various modifications of the disclosed embodiment as well as alternative embodiments of the invention will become apparent to one skilled in the art upon reference to the description of the invention.

I claim:

1. An anti-theft device for use in securing the release of the air-operated parking brake valves on a tractor-trailer rig, said device comprising:
a. a pair of mating halves;
b. a lock having a locking pin operable by inserting and turning a key in said lock, said lock being disposed for securing said halves together; and,
c. said halves being formed for surrounding and enclosing the air brake release valves while in an engaged position in order to prevent release thereof without a key for said lock.

2. A device as in claim 1 wherein a first of said halves including a tongue with an opening therein and a second of said halves including a channel for receiving said tongue.

3. A device as in claim 2 wherein said second half includes said lock and locking pin for engaging the opening in said tongue.

4. A device as in claim 1 wherein a first half of said mating halves includes adjustment mechanisms for adjusting said lock to the air-brake release valves of a particular tractor-trailer rig.

5. A device as in claim 4 wherein said adjustment mechanisms are screws secured into said first of said halves.

6. A device as in claim 1 wherein said device is formed from plastic.

7. A device as in claim 1 wherein said device is formed from metal.

8. An anti-theft device for a vehicle employing air-operated parking brakes, said device being disposed about said parking brake release valves when engaged, said device comprising:
a. a pair of mating halves formed for surrounding and enclosing said control valves while in an engaged position, wherein a first of said halves including a tongue having an opening therein and a second of said halves including a channel for receiving said tongue;
b. a lock having a locking pin being disposed in said second half wherein said locking pin engages said opening in said tongue in order to secure said first and second halves together.

9. A device as in claim 8 wherein said device is formed from a poly-carbon fiber.

10. A device as in claim 8 wherein said device is formed from plastic.

11. A device as in claim 8 wherein a first half of said mating halves includes adjustment mechanisms for adjusting said device to the air-brake release valves of a particular tractor-trailer rig.

12. A device as in claim 11 wherein said adjustment mechanisms are screws secured into said first of said halves.

13. An anti-theft device for a vehicle employing air-operated parking brakes, said device being disposed about said parking brake release valves when engaged, said device comprising:
a. a pair of mating halves formed for surrounding and enclosing said control valves while in an engaged position, wherein a first of said mating halves including a tongue having an opening therein and a second of said mating halves including a channel for receiving said tongue;
i) said first of said mating halves having a first pair of recesses for receiving the tops of said release valves and a second pair of recesses, smaller than said first pair, for receiving the shafts of said release valves;
ii) said second of said mating halves having a third pair of recesses mating with said first pair of recesses for receiving the tops of said release valves and a fourth pair of recesses, smaller than said third pair and mating with said second pair, for receiving the shafts of said release valves; and,
b. a lock having a locking pin being disposed in said second half wherein said locking pin engages said opening in said tongue in order to secure said first and second halves together.

14. A device as in claim 13 wherein said device is formed from a poly-carbon fiber.

15. A device as in claim 13 wherein said device is formed from plastic.

16. A device as in claim 13 wherein a first half of said mating halves includes adjustment mechanisms located in said pair of recesses for adjusting said device to the air-brake release valves of a particular tractor-trailer rig.

17. A device as in claim 16 wherein said adjustment mechanisms are screws secured into said first pair of recesses for fitting the back side of the tops of said release valves.
